(19) United States
(12) Patent Application Publication
(10) Pub. No.: US 2005/0278091 A1
(43) Pub. Date: Dec. 15, 2005

(54) Dual image display

(75) Inventors: Robert J. Burnham, Novi, MI (US); Sorin M. Panainte, Taylor, MI (US); Paul Fredrick Luther Weindorf, Novi, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 10/866,271

(22) Filed: Jun. 10, 2004

(51) Int. Cl. G06F 17/00

(52) U.S. Cl. 701/36; 701/1

(57) ABSTRACT

An improved display system for automotive applications is provided. The display system includes a display controller, a display, a driver information system, and a vehicle entertainment system. The display controller is in communication with the display to provide a driver side image and a passenger side image. The driver information system is in communication with the display controller to provide information used to generate the driver side image. The vehicle entertainment system is also in communication with the display controller to provide a video signal used to generate the passenger side image.

### BACKGROUND

1. Field of the Invention

The present invention generally relates to a multiple display system for automotive applications.

2. Description of Related Art

Vehicle entertainment systems are commonly provided to rear seat passengers. Currently, the driver of a motor vehicle is required by law, in many states, not to watch video images from a vehicle entertainment system, while driving a vehicle. Due to the requirement that drivers are not allowed to view vehicle entertainment systems while driving, the front passenger is typically also not provided with the ability to view images from a vehicle entertainment system.

Systems have been developed that allow the passenger to view images from a vehicle entertainment system while blocking the view of the driver, for example by using louvers to restrict the viewing angle of the display screen. However, little space is available in the dash board area for mounting an additional display to provide the passenger an individual display for the purposes of utilizing a vehicle entertainment system. Typically, space in the dash board area is used for providing the driver of the vehicle information such as vehicle status information or for housing safety devices, such as, air bags.

In view of the above, it is apparent that there exists a need for an improved display system for automotive applications.

### SUMMARY

In satisfying the above need, as well as overcoming the enumerated drawbacks and other limitations of the related art, the present invention provides an improved display system for automotive applications. The display system includes a display controller, a display, a navigation system, and a vehicle entertainment system. The display controller is in communication with the display to provide a driver side image and a passenger side image. The navigation system is in communication with the display controller to provide information used to generate the driver side image. The vehicle entertainment system is also in communication with the display controller to provide a video signal used to generate the passenger side image.

In another aspect of the present invention, a vehicle information system is in communication with the display controller to provide vehicle status information used to generate the driver side image.

In another aspect of the present invention, a vehicle information system generates a control signal indicating a driver side configuration.

In yet another aspect of the present invention, the vehicle information system provides a control signal indicating a non-driving state exists. The display controller is configured to generate the driver side image based on the video signal from the vehicle entertainment system when the control signal indicates the vehicle is in a non-driving state. Further, the display controller monitors the control signal indicating a non-driving state and automatically stops displaying the driver side image based on the video signal from the vehicle entertainment system when the non-driving state ends.

Further objects, features and advantages of this invention will become readily apparent to persons skilled in the art after a review of the following description, with reference to the drawings and claims that are appended to and form a part of this specification.

### BRIEF DESCRIPTION OF THE DRAWINGS

FIG. 1 is a block diagram of a display system in accordance with the present invention; and

FIG. 2 is an elevated view of one embodiment of the display in accordance with the present invention.

### DETAILED DESCRIPTION

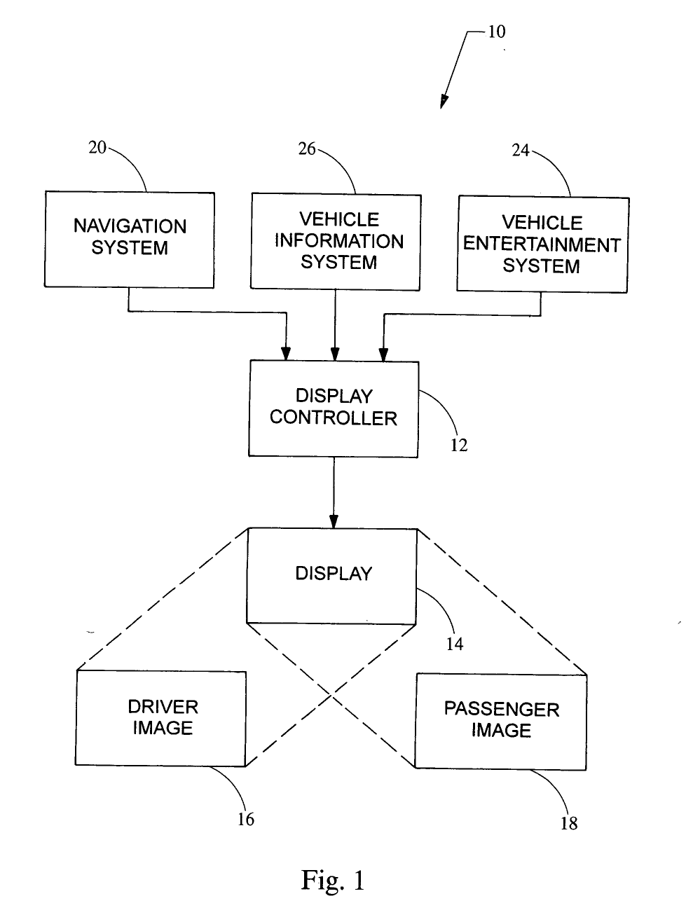

Referring now to FIG. 1, a display system embodying the principles of the present invention is illustrated therein and designated at 10. The display system 10 includes a display controller 12, display 14, vehicle entertainment system 24, and a driver information system, such as a navigation system 20 or a vehicle status system 26. The display controller 12 is in communication with the display 14 and configured to generate images to be shown on the display 14. The display 14 is configured to show two images on a display screen simultaneously. Each of the two images are independently viewable from different angles relative to the surface of the display 14. The display 14 is configured such that the first image, referred to as the driver image 16, is viewable from the driver seat of the vehicle. The second image, referred to as the passenger image 18, is viewable from the passenger seat of the vehicle and is specifically not viewable from the driver seat of the vehicle.

Various configurations of display hardware may be used to simultaneously display two images that are independently viewable from different view angles. One such configuration is provided in U.S. Pat. No. 6,593,904, issued to März et al., which is incorporated herein by reference, and yet another configuration is described below.

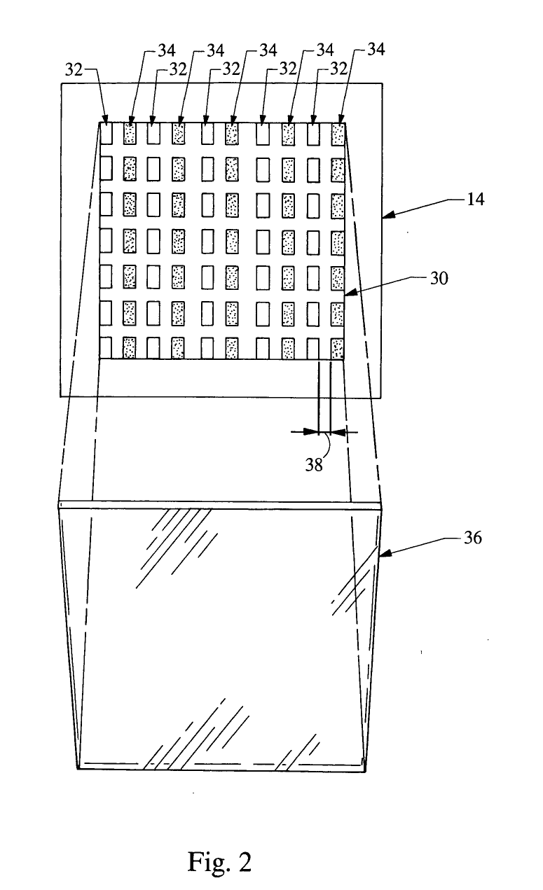

Referring to FIG. 2, the display 14 includes a display screen 30 having rows and columns of pixels. The driver side image and passenger side image may be interlaced such that alternating driver side image columns 32 and passenger side image columns 34 may be used to simultaneously display the driver side and passenger side image. A polarizer 36, such as a parallax barrier polarizer or active LCD film, is then synchronized with the pixel spacing 38 between the driver side image columns 32 and the passenger side image columns 34 to limit the viewing angle for the driver side image 16 based on the driver seat position and limit the viewing angle of the passenger side image 18 based on the passenger seat position. The display implementation described above is one of many possible implementations for displaying two images, each with a limited viewing angle. As such, the specific display implementation for limiting the viewing angle of an image on the screen is not intended to be limiting on the scope of the claims.

Referring again to FIG. 1, the navigation system 20 is connected to the display controller 12 to provide information used to generate the driver image 16. Information from the navigation system 20 may include destination, location, route, logistical or other navigational information and may be presented in textual or graphical form. The vehicle entertainment system 24 is connected to the display controller 12 to provide a video signal, such as a DVD signal, that can be provided to the display 14 for generation of the passenger image 18, thereby entertaining the passenger. As previously noted, the passenger image 18 would generally be non-viewable to the driver of the vehicle, due to the limited viewing angle of the passenger side image 18.

The driver information system may include, alternately or in addition to the navigation system 20, a vehicle status system 26 in communication with the display controller 12 to provide control signals to the display controller 12 regarding status information of the vehicle. The vehicle status system 26 provides a signal to the display controller 12 to incorporate vehicle status information such as speed, miles traveled, fault conditions, fuel consumption, rearward video or other status video, or other vehicle status information into the driver side image 16. Being displayed in either textual or graphical form, the vehicle status information may be combined with the navigational information or displayed independently.

In addition, the vehicle status system 26 provides a control signal indicating a driver side configuration of the vehicle. The control signal includes whether the vehicle is a left side driver vehicle, as used in the United States, or a right side driver vehicle, as used in the United Kingdom. The display controller 12 would have the ability to display the driver side image 16 viewable on the right or left side of the display 14 based on the driver side configuration of the vehicle. For a left driver side vehicle the display controller 12 is configured to display the driver side image 16 being viewable on the left-hand side of the vehicle. Conversely, the display controller displays the driver side image 16 on the right-hand side of the vehicle for a right driver side vehicle configuration. Accordingly, the passenger side image 18 is displayed on the right side of the vehicle for a left side driver vehicle configuration, and the passenger side image 18 is displayed viewable from the left-hand side of the vehicle in a right side driver vehicle configuration.

In addition, the vehicle status system 26 provides a control signal indicating a non-driving state exists. When a non-driving state exists, the display controller 12 may generate a driver side image 16 based on the video signal from the vehicle entertainment system 24. The display controller 12 is configured to continuously monitor the control signal indicating driving state, such that, if the vehicle enters a driving state, the display controller 12 automatically stops providing the driver image 16 based on the vehicle entertainment system 24. Further, the display controller 12 reverts to a driver side image based on the navigation system 20 or the vehicle status system 26.

The display system 10 also has the capability to generate the passenger side image 18 based on information from the driver information system. For example this would include navigation information from the navigation system 20 or vehicle status information from the vehicle status system 26. In addition, the passenger is provided access to functions which are normally driver restricted function, such as, navigation functions not available to the driver while the vehicle is in a driving state. Driver restricted functions may include but are not limited to point of interest entry, destination entry, map pan functions, or map zoom functions.

As a person skilled in the art will readily appreciate, the above description is meant as an illustration of the principles of this invention. This description is not intended to limit the scope or application of this invention in that the invention is susceptible to modification, variation and change, without departing from spirit of this invention, as defined in the following claims.

1. A display system for automotive applications, the display system comprising:
a display controller;
a display screen in communication with the display controller to receive a driver side image and a passenger side image, the display screen being configured to display both the passenger side image and the driver side image on the display screen;
a driver information system in communication with the display controller to provide information used to generate the driver side image; and
a vehicle entertainment system in communication with the display controller to provide a video signal corresponding to the passenger side image.

2. The display system according to claim 1, wherein the driver information system is a vehicle status system in communication with the display controller to provide vehicle status information used to generate the driver side image.

3. The display system according to claim 1, wherein the driver information system is a navigation system in communication with the display controller to provide vehicle status information used to generate the driver side image.

4. The display system according to claim 1, wherein the driver information system is a vehicle status system in communication with the display controller, the vehicle status system being configured to generate a control signal indicating a driver side configuration, the display controller being configured to display the driver side and passenger side image based on the driver side configuration signal.

5. The display system according to claim 1, wherein the driver information system includes a vehicle status system in communication with the display controller, the vehicle status system providing a control signal indicating a non-driving state when the vehicle is in such a state, the display controller being configured to generate the driver side image based on the video signal from the vehicle entertainment system when the control signal indicates the non-driving state.

6. The display system according to claim 5, wherein the display controller monitors the control signal indicating the non-driving state exists and automatically stops displaying the driver side image based on the video signal from the vehicle entertainment system when the non-driving state ends.

7. The display system according to claim 6, wherein the display controller is configured to display the driver side image based on the vehicle navigation system when the non-driving state ends.

8. The display system according to claim 1, wherein the passenger side image is viewable from a first angle and the driver side image is viewable from a second angle, the passenger side image not being directly viewable from the second angle.

9. The display system according to claim 1, wherein the passenger side image is generated based on the driver information system.

10. The display system according to claim 9, wherein the passenger side image provides access to functions that are driver restricted functions.

11. A method for displaying a driver side and passenger side image for automotive application, the method comprising:
receiving driving information from a driver information system;
receiving a video signal from a vehicle entertainment system;
generating a driver side image based on the driving information;
generating a passenger side image based on the video signal; and
displaying the driver side and passenger side image on a common display screen.

12. The method according to claim 11, further comprising providing vehicle status information from the driver information system used to generate the driver side image.

13. The method according to claim 11, further comprising providing navigational information from the driver information system used to generate the driver side image.

14. The method according to claim 11, further comprising generating a control signal indicating a driver side configuration and displaying the driver side image and the passenger side image based on the driver side configuration signal.

15. The method according to claim 14, further comprising providing a control signal indicating a non-driving state, and generating the driver side image based on the video signal from the vehicle entertainment system when the control signal indicates the non-driving state exists.

16. The method according to claim 15, further comprising monitoring the control signal indicating the non-driving state exists and ceasing the display of the driver side image, based on the video signal from the vehicle entertainment system, when the non-driving state ends.

17. The method according to claim 16, further comprising displaying the driver side image based on the driver information system when the non-driving state ends.

18. The method according to claim 11, further comprising the step of making the passenger side image is not directly viewable from a driver side position.

19. The method according to claim 11, further comprising generating the passenger side image based on the driver information system.

20. The method according to claim 19, wherein the passenger side image provides access to functions that are driver restricted functions.
